(19) United States
(12) Patent Application Publication
(10) Pub. No.: US 2006/0277207 A1
(43) Pub. Date: Dec. 7, 2006

(54) Enterprise business intelligence using email analytics

(76) Inventor: Michael J. Ure, Cupertino, CA (US)

Correspondence Address: Michael J. Ure, 10518 Phil Place, Cupertino, CA, 95014, US

(21) Appl. No.: 11/145,713

(22) Filed: Jun. 6, 2005

(51) Int. Cl. G06F 7/00

(52) U.S. Cl. 707/102

(57) ABSTRACT

The present invention, generally speaking, provides a visual email analytics tool in which a network graph is created without the need to identify any particular node of the network graph. The complexity of the network graph is controlled by interactively pruning the network graph based on one or more measures of relatedness, such as the number of emails exchanged, clustering attributes, etc. Node-by-node pruning is also provided for. A privilege/consent system governs the viewing of emails. The tool enables a user to quickly and easily identify the relevant players and activities with respect to a particular subject.

### BACKGROUND OF THE INVENTION

1. Field of the Invention

The present invention relates to email analytical software.

2. State of the Art

U.S. Pat. No. 6,594,673 describes a system for interactive visualization of “threaded message information” such as USENET newsgroup information. The system is designed to enable users to navigate and participate effectively in such groups without the need for extended participation in order to become familiar with the group, which may suffer from off-topic and poorly-targeted messages. A user selects one or more topics or posts or posters in response to which related topics or posts or posters are displayed in the form of a network graph, edges of the graph indicating the degree of relatedness. A user adjustment allows the user to set a threshold relatedness, thereby limiting the information displayed to a desired degree of detail. Stratify Inc. of Mountain View Calif. offers electronic discovery software including email analytic capabilities. The user may search an email database and from the search results select a sender/receiver pair. The user may also specify emails sent directly from the specified sender to the specified receiver or emails sent either directly or indirectly, through a selectable number of intermediate parties. Based on the selections, a network graph is displayed with edges labeled to indicate the number of emails sent between the email users in accordance with the selection criteria. Clicking on an edge allows the emails represented by that edge to be displayed. In large enterprises, the difficulty arises that because communications are decentralized, different parts of the enterprise may sometimes act at cross purposes to one another. A tool is needed that overcomes this difficulty. The prior art does not address this need.

### SUMMARY OF THE INVENTION

The present invention, generally speaking, provides a visual email analytics tool in which a network graph is created without the need to identify any particular node of the network graph. The complexity of the network graph is controlled by interactively pruning the network graph based on one or more measures of relatedness, such as the number of emails exchanged, clustering attributes, etc. Node-by-node pruning is also provided for. A privilege/consent system governs the viewing of emails. The tool enables a user to quickly and easily identify the relevant players and activities with respect to a particular subject.

### BRIEF DESCRIPTION OF THE DRAWING

The present invention may be further understood from the following description in conjunction with the appended drawing. In the drawing:

FIG. 1 is block diagram of a system in which the present invention may be used.

FIG. 2 is an exemplary display screen illustrating one possible user interface of the system of FIG. 1.

### DETAILED DESCRIPTION OF THE PREFERRED EMBODIMENTS

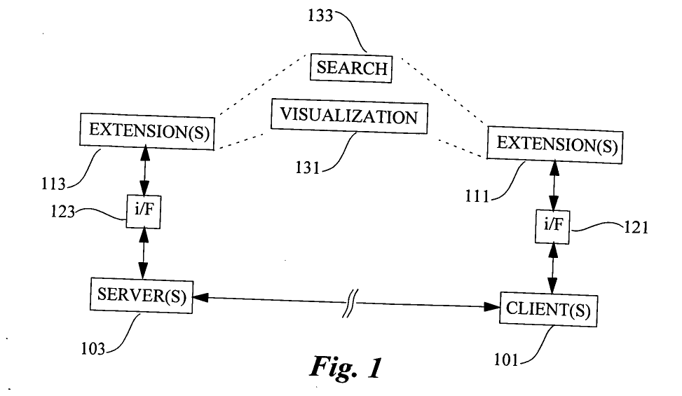

Referring now to FIG. 1, a block diagram is shown of an information retrieval and display system in accordance with the present invention. The system is represented as a client/server system in which one or more clients 101 access one or more servers 103. Both the clients 101 and the servers 103 may be geographically distributed as is typically the case for a networked worldwide enterprise and may include thousands or tens of thousands of servers and tens or hundreds of thousands of clients.

Any of various techniques may be used to achieve coordination of many email servers distributed worldwide. One technique is to apply a client patch to all of the clients to cause every email to transparently be sent to a centralized email server or server cluster that search-indexes the email and may then discard it. Various other techniques will be apparent to one of ordinary skill in the art. For simplicity, the client 101 and the server 103 will hereinafter be referred to in the singular case.

The server may be an email server such as Microsoft Exchange Server™ or a Lotus Notes™ server. Although a client/server architecture has been assumed for purposes of description, the invention may also be applied to other architectures.

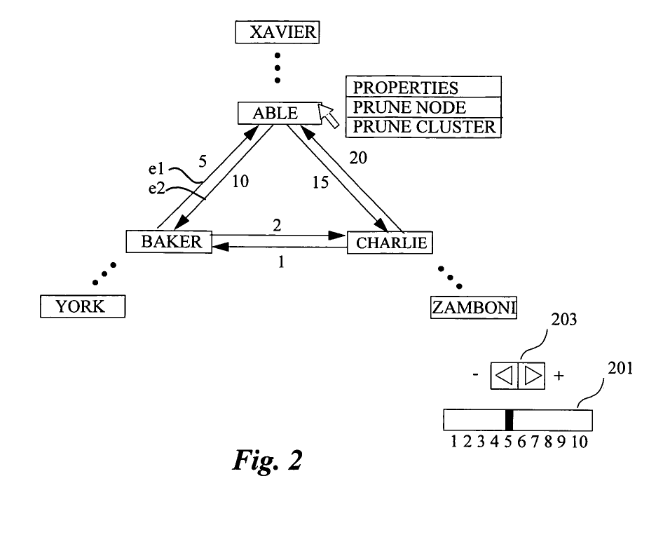

Enterprise email servers typically provide for extensibility such that third party software may interface to and extend the functionality of the email server. Extensions (e.g., 111, 113) may be applied on the server side, the client side, or both and interoperate with the server or the client through a public interface (e.g., 121, 123). In the example of FIG. 1, the extensions include a search module 131 and a visualization module 133. The search module 131 maintains a search index of emails accessible through the email server and allows emails to be searched, similar to the search capabilities of Google's Gmail™ service, for example. The visualization module 133 operates on the results identified by the search module in the following manner. The visualization module creates a representation of the search results in the form of a network graph, shown for example in FIG. 2, in which each email sender and email recipient is represented as a node and emails are represented as edges.

For example, in FIG. 2, the edges e2 and e1, respectively, represent that Abel sent to Baker 10 emails satisfying the search criteria and Baker sent to Abel 5 emails satisfying the search criteria. The underlying logical representation of the network graph may be distinct from the visual representation and may take any of a number of well-known forms. The visualization module 133 also displays the network graph in accordance with a suitable visual representation to allow for interactive pruning/growing of the network graph. Suitable software for performing some or all of the foregoing tasks is available from Tom Sawyer Software of Oakland Calif. and/or Stratify Inc. of Mountain View Calif. In the example of FIG. 2, the user is able to click on an edge in order to access the emails represented by that edge. A dual-control user interface may be provided for controlling pruning/growing of the network graph. A slider control 201 may be used to control granularity of the pruning/growing operations. An increment/decrement control 203 causes the network graph to be pruned or grown in accordance with the specified granularity. The visualization software of Tom Sawyer Software is especially suited for such user interaction, as it preserves the appearance of the network graph of the greatest extent possible during editing.

In the example of FIG. 2, by clicking on a node, a user may view additional properties of the nodes (besides the name of the node, which is typically displayed as a label by default). The user may also prune a node or prune a cluster of nodes to which the node belongs. Again, the visualization software of Tom Sawyer Software is especially suitable, as it identifies clusters of nodes based on connectedness and displays them by applying different colors.

The functionality of the information retrieval and display system may be built into popular email servers such as Microsoft Exchange Server and Lotus Notes and hence be made widely available throughout the global enterprise. Nevertheless, various restrictions may be applied to protect sensitive information. Examples of various protection arrangements will now be described. In accordance with one aspect of information protection, the capabilities of the information retrieval and display system are made available only to managers of a certain level. In order to use the capabilities of the system, a user would work in concert with his or her manager in order to use the tool. In accordance with another aspect of information protection, different users may be assigned different levels of privilege, and different emails may be assigned different levels of sensitivity. In order to access an email of a particular level of sensitivity, a sufficient level of privilege is required. In accordance with another aspect of information protection, emails users are assigned different levels of sensitivity. Access to emails to and from the CEO, for example, would require a higher level of privilege than other emails. In accordance with another aspect of information protection, an email may be generated and sent to the sender of an email or collection of emails sent by a particular user requesting permission to view. In accordance with another aspect of information protection, a search may be executed and the results submitted to a supervisor for approval prior to viewing being allowed. In accordance with another aspect of information protection, different parts of an email may be protected differently. For example, the subject line may always be visible. Similarly, the search term may be viewed in context with less stringent permission than viewing the entire email. These various aspects of information protection may be applied in various combinations.

It will be appreciated by those of ordinary skill in the art that the invention can be embodied in other specific forms without departing from the spirit or essential character thereof. The presently disclosed embodiments are therefore considered in all respects to be illustrative and not restrictive. The scope of the invention is indicated by the appended claims rather than the foregoing description, and all changes which come within the meaning and range of equivalents thereof are intended to be embraced therein.

What is claimed is:

1. A method of information retrieval and display comprising:
searching a message database using search criteria based on message content;
displaying a network graph representing messages satisfying the search criteria; and
interactively pruning or growing the network graph;
wherein a user is not required to identify any specific node of the network graph prior to displaying the network graph.

2. The method of claim 1, wherein edges of the network graph are directed edges representing a sender/receiver relationship between connected nodes, at least some nodes having both incoming and outgoing edges.

3. A computer readable medium storing instructions comprising instructions for:
searching a message database using search criteria based on message content;
displaying a network graph representing messages satisfying the search criteria; and
interactively pruning or growing the network graph;
wherein a user is not required to identify any specific node of the network graph prior to displaying the network graph.

4. The apparatus of claim 3, wherein edges of the network graph are directed edges representing a sender/receiver relationship between connected nodes, at least some nodes having both incoming and outgoing edges.
